(19) United States
(12) Patent Application Publication
(10) Pub. No.: US 2015/0323351 A1
(43) Pub. Date: Nov. 12, 2015

(54) REFLECTIVE OPTICAL ENCODER HAVING RESIN-MADE CODE PLATE

(71) Applicant: FANUC CORPORATION, Minamitsuru-gun (JP)

(72) Inventor: Akinobu Sakata, Yamanashi (JP)

(73) Assignee: FANUC CORPORATION, Minamitsuru-gun (JP)

(21) Appl. No.: 14/704,386

(22) Filed: May 5, 2015

(30) Foreign Application Priority Data
May 7, 2014 (JP) 2014-096184

(51) Int. Cl. G01D 5/347

(52) U.S. Cl. CPC G01D 5/3473

(57) ABSTRACT

A reflective optical encoder, which is inexpensive and is compact in the axial direction thereof. A first major surface of a code plate has an incidence part having a first transmission portion and a second transmission portion, and an emission part with a concavo-convex shape. A second major surface of the code plate has a flat surface portion. The first transmission portion has a concavo-convex shape configured to guide light after entering the first transmission portion so as to be totally reflected by the flat surface portion. The second transmission portion is a flat surface, for example, configured to guide light after entering the second transmission portion so as not to be totally reflected by the flat surface portion.

### BACKGROUND OF THE INVENTION

1. Field of the Invention

The present invention relates to a reflective optical encoder having a code plate made of resin.

2. Description of the Related Art

An optical encoder is connected to a rotation axis, etc., of a motor, and is used to detect the rotational position and velocity of the rotation axis. As an example of such an encoder, JP 2004-325231 A discloses an optical encoder having a light emitting unit positioned near one side of a resin-made code plate and a light receiving unit positioned near the other side of the code plate, wherein light from the light emitting unit passes through the code plate and is received by the light receiving unit.

On the other hand, JP H11-287671 A discloses an optical encoder having a light emitting unit and a light receiving unit positioned near the same side of a code plate, wherein light from the light emitting unit is reflected by the code plate and is received by the light receiving unit.

In the encoder disclosed in JP 2004-325231 A, the light emitting unit and the light receiving unit are positioned near the opposed sides of the code plate. Therefore, an axial dimension of the encoder is relatively large. On the other hand, in the configuration of JP H11-287671 A (FIG. 12, etc.), it is necessary to selectively reflect or transmit the light from the light emitting unit. However, JP H11-287671 A does not disclose a concrete means for obtaining a desired function of the encoder, in view of an incidence angle or a reflection angle of the light at the code plate, and the positional relationship between the light emitting unit and the light receiving unit.

### SUMMARY OF THE INVENTION

Thus, the object of the present invention is to provide a reflective optical encoder which is inexpensive and compact in the axial direction thereof.

The present invention provides a reflective optical encoder comprising: a code plate which is formed of a resin material and has a first major surface and a second major surface opposite of the first major surface; a light emitting unit positioned near the first major surface of the code plate; and a light receiving unit positioned near the first major surface of the code plate, wherein the second major surface of the code plate has a flat surface portion, and the first major surface of the code plate has an incidence part having a first transmission portion and a second transmission portion, and an emission part with a concavo-convex shape, and wherein the first transmission portion has a V-shape, a triangular shape or a curved surface configured to guide light after entering the first transmission portion so as to be totally reflected by the flat surface portion of the second major surface, and the second transmission portion is configured to guide light after entering the second transmission portion so as not to be totally reflected by the flat surface portion of the second major surface.

In a preferred embodiment, the second transmission portion of the incidence part is a flat surface portion.

In a preferred embodiment, the concavo-convex shape of the emission part is a V-shape or triangular shape.

In another preferred embodiment, the concavo-convex shape of the emission part is a curved shape.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 is a basic configuration of a reflective optical encoder according to the present invention;

FIG. 2a shows a working example wherein a first transmission portion is formed from a plurality of triangular shapes, an emission part is formed from a plurality of triangular shapes, and an A-phase part of a light receiving unit is “bright;”

FIG. 2b shows a working example wherein a first transmission portion is formed from a plurality of triangular shapes, an emission part is formed from a plurality of triangular shapes, and a B-phase part of a light receiving unit is “bright;”

FIG. 3 shows a working example wherein a first transmission portion is formed from one V-shape, and an emission part is formed from a plurality of triangular shapes;

FIG. 4 shows a working example wherein a first transmission portion is formed from one triangular shape, and an emission part is formed from a plurality of triangular shapes;

FIG. 5 shows a working example wherein a first transmission portion is formed a plurality of V-shapes, and an emission part is formed from a plurality of triangular shapes;

FIG. 6 shows a working example wherein a first transmission portion is formed from a plurality of triangular shapes, and an emission part is formed from a plurality of triangular shapes;

FIG. 7 shows a working example wherein a first transmission portion is formed from one curved surface, and an emission part is formed from a plurality of triangular shapes;

FIG. 8 shows a working example wherein a first transmission portion is formed from a plurality of curved surfaces, and an emission part is formed from a plurality of triangular shapes;

FIG. 9 shows a working example wherein a first transmission portion is formed from a plurality of V-shapes, and an emission part is formed from one V-shape;

FIG. 10 shows a working example wherein a first transmission portion is formed from a plurality of V-shapes, and an emission part is formed from one triangular shape;

FIG. 11 shows a working example wherein a first transmission portion is formed from a plurality of V-shapes, and an emission part is formed from a plurality of V-shapes;

FIG. 12 shows a working example wherein a first transmission portion is formed from a plurality of V-shapes, and an emission part is formed from a plurality of triangular shapes;

FIG. 13 shows a working example wherein a first transmission portion is formed from a plurality of V-shapes, and an emission part is formed from one curved surface; and

FIG. 14 shows a working example wherein a first transmission portion is formed from a plurality of V-shapes, and an emission part is formed from a plurality of curved surfaces.

### DETAILED DESCRIPTION

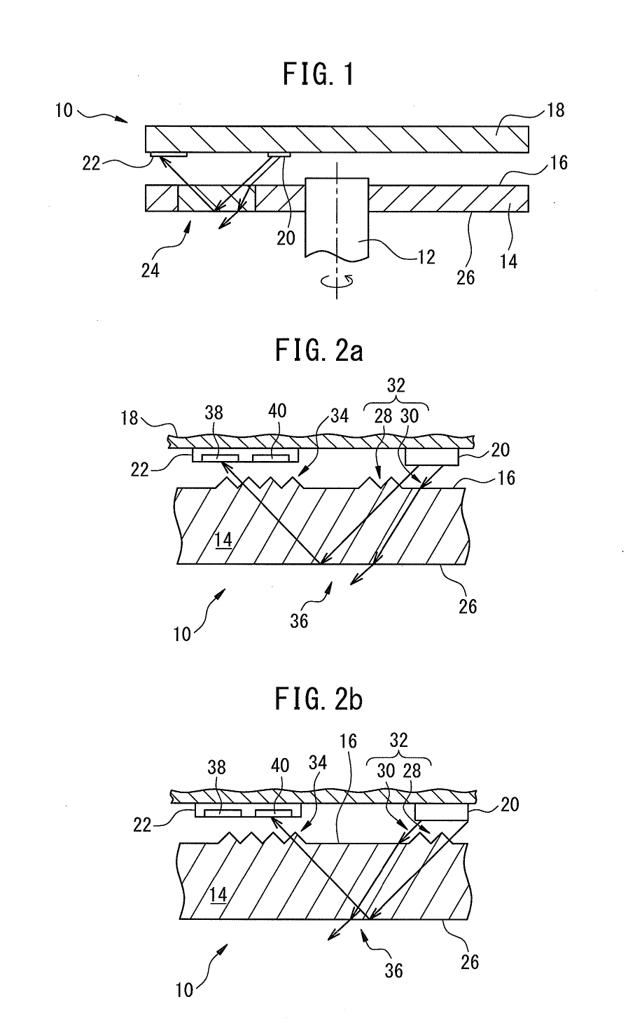

FIG. 1 is an axial cross-sectional view showing a schematic basic configuration of a reflective optical encoder 10 according to an embodiment of the invention. Encoder 10 has a generally circular code plate 12 fixed to a rotating body, such as a schematically shown rotation shaft 12 of a motor, and a printed board 18 separated from and opposite of a first major surface 16 (or an upper surface in the drawing). On the printed board 18, a light emitting unit 20 and a light receiving unit 22 are positioned so as to be separated from each other. In other words, light emitting unit 20 and light receiving unit 22 are positioned on the same side (in the drawing, near first major surface 16) of code plate 14. Code plate 14 is made from a light transmissive resin, and has a code pattern 24, which reflects or transmits light from light emitting unit 20.

As shown in FIG. 1, light emitting unit 20 emits light toward first major surface 16, and a part of the light after entering first major surface 16 is totally or completely reflected by second major surface 26 opposite of first major surface 16 and then is received by light receiving unit 22. On the other hand, the remaining light after entering first major surface 16 is not totally reflected by second major surface 26, i.e., is output from second major surface 26 to the outside (in the drawing, downward). Hereinafter, various embodiments of encoder 10 will be explained.

FIG. 2a is an axial cross-sectional view showing a major part of reflective optical encoder 10. First major surface 16 of code plate 14 has an incidence part 32 including first transmission portion 28 and a second transmission portion 30, and an emission part 34 with a concavo-convex shape (in this case, a plurality of triangular shapes). On the other hand, second major surface 26 has a flat surface portion 36, and first transmission portion 28 has a concavo-convex shape (in this case, a plurality of triangular shapes) which guides the light so as to be totally reflected by flat surface portion 36. Second transmission portion 30 is configured to guide the light so as not to be totally reflected by flat surface portion 36. Although second transmission portion 30 is a flat surface, second transmission portion 30 may have any shape, such as a concavo-convex shape, as long as the light after entering second transmission portion 30 is not totally reflected by flat surface portion 36.

In other words, in encoder 10, among the light entering incidence part 32 from light emitting unit 20, a part of the light, after entering second transmission portion 30, travels within code plate 14 and is output from flat surface portion 36 of second major surface 26 without being totally reflected by flat surface portion 36. On the other hand, the remaining light, after entering first transmission portion 28, is totally reflected by flat surface portion 36, travels within code plate 14 again, is output from emission part 34, and is received by light receiving unit 22. In the illustrated embodiment, after the light from light emitting unit 20 enters first transmission portion 28 having a surface generally perpendicular to the direction of the light, the light is not substantially refracted by first transmission portion 28, and reaches flat surface portion 36 so that the light is totally reflected by flat surface portion 36. On the other hand, after the light enters second transmission portion 30 constituted by a flat surface, for example, is refracted by second transmission portion 30, and is output from second major surface 26 without being totally reflected by flat surface portion 36.

Light receiving unit 22 has an A-phase part 38 and a B-phase part 40. In a state of FIG. 2a, light is reflected by flat surface portion 36, is output from emission part 34, and then is received by A-phase part 38. In other words, in the state of FIG. 2a, A-phase part 38 is “bright” and B-phase part 40 is “dark.” On the other hand, in a state of FIG. 2b in which code plate 14 is rotated by a predetermined angle from the state of FIG. 2a, light is reflected by flat surface portion 36, is output from emission portion 34, and then is received by B-phase part 40. In other words, in the state of FIG. 2b, A-phase part 38 is “dark” and B-phase part 40 is “bright.” As such, when code plate 14 is rotated, “bright” and “dark” are alternately changed between A-phase part 38 and B-phase part 40, whereby a cyclic signal, such as a pulse wave, a triangular wave or a sine wave, is obtained. By virtue of this, the rotational angular position and the rotational velocity of the rotating body, to which code plate 14 is fixed, can be measured. Since such a basic function of the encoder may be common to embodiments as described below, only the state wherein A-phase part 38 is “bright” will be explained in the following embodiments.

In encoder 10 of the present invention, since both light emitting unit 20 and light receiving unit 22 are positioned at or near the same side of code plate 14, the encoder can be compact in the axial direction thereof. By forming first transmission portion 28 and second transmission portion 30 on incidence part 32 of first major surface 16, the light, after entering incidence part 32, can be appropriately divided into the light which is totally reflected by flat surface portion 36 of second major surface 26 and the light which is not totally reflected by flat surface portion 36. Therefore, it is not necessary to form a concavo-convex shape on second major surface 26, and it is possible to form second major surface 26 as a flat surface only, whereby code plate 24 may have a simple structure and a cost of the encoder may be reduced. Also, second transmission portion 30 may be formed as a flat surface, and a cost of the encoder may be further reduced. In addition, as an inexpensive and compact device, wherein the light emitting unit and the light receiving unit are previously packaged, may be used for the encoder. This is also applicable to embodiments as explained below.

As a concrete example for the concavo-convex shape of first transmission portion 28 of incidence part 32 and emission part 34, a V-shape and a curved surface may be used, as well as the triangular shape as described above. Hereinafter, embodiments thereof will be explained.

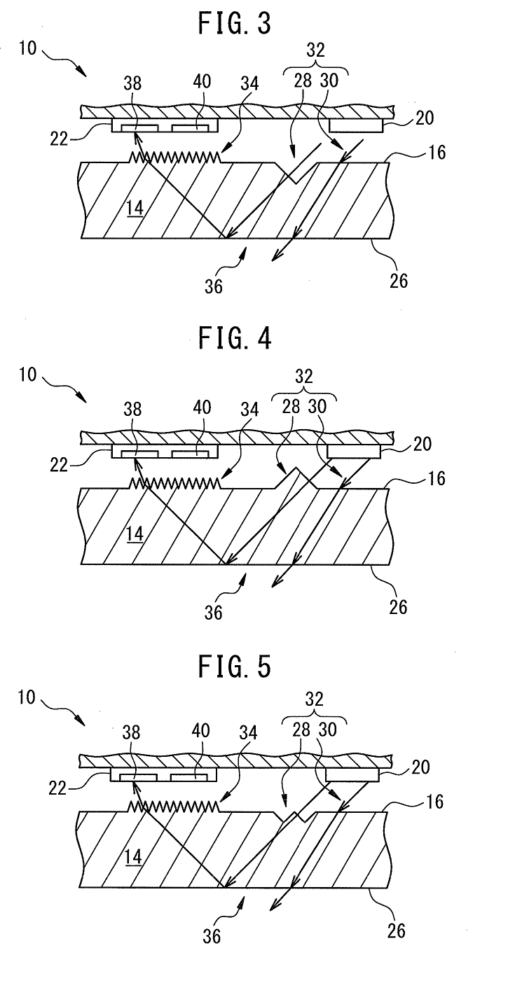

FIG. 3 shows a working example wherein first transmission portion 28 of incidence part 32 is formed from one V-shape (V-groove), and emission part 34 is formed from a plurality of triangular shapes. On the other hand, FIG. 4 shows a working example wherein first transmission portion 28 of incidence part 32 is formed from one triangular shape (prism), and emission part 34 is formed from a plurality of triangular shapes. Herein, a structure, which dents from first major surface 16 and has a V-shape in an axial cross-section, is referred to as a “V-shape (or V-groove),” and a structure, which protrudes from first major surface 16 and has a triangular shape in the axial cross-section, is referred to as a “triangular shape.”

In the working example of FIG. 3, light from light emitting unit 20 is directed to flat surface portion 36 without being deflected by first transmission portion 28 (i.e., the light vertically enters an inclined surface constituting first transmission portion 28). Then, the light is totally reflected by flat surface portion 36, is output from emission part 34, and is received by light receiving unit 22. In this case, as shown in FIG. 2a or 2b, emission part 34 may be configured to substantially refract the light, otherwise, as shown in FIG. 3, may be configured to refract the light toward light emitting unit 20.

Similarly, in the working example of FIG. 4, light from light emitting unit 20 is directed to flat surface portion 36 without being deflected by first transmission portion 28 (i.e., the light vertically enters an inclined surface constituting first transmission portion 28). Then, the light is totally reflected by flat surface portion 36, is output from emission part 34, and is received by light receiving unit 22. Also in this case, emission part 34 may be configured to substantially refract the light, otherwise, as shown in FIG. 4, may be configured to refract the light toward light emitting unit 20. When the light is refracted toward light emitting unit 20 by light emission part 34, light receiving unit 22 can be positioned closer to light emitting unit 20, whereby the encoder can be compact in the radial direction thereof.

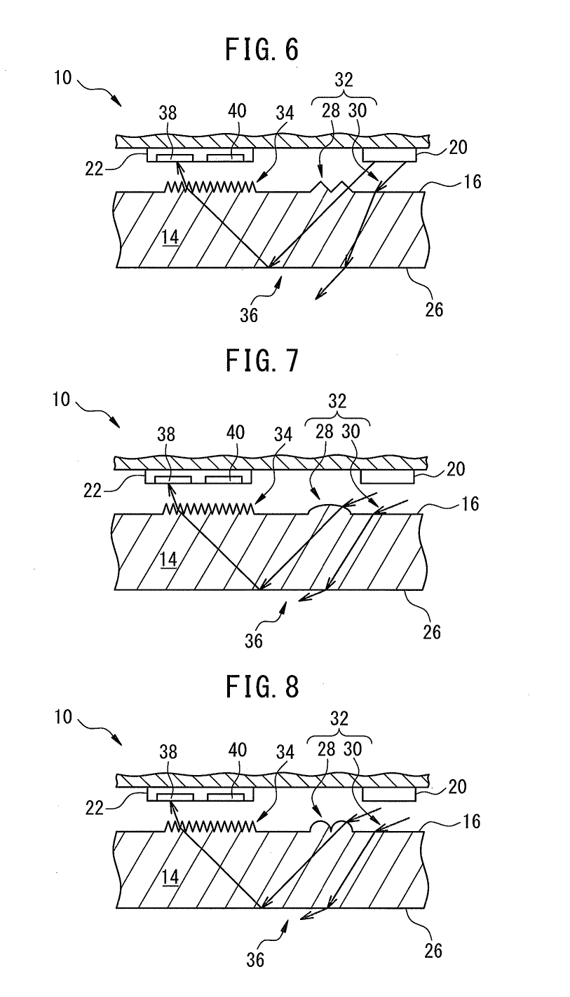

FIG. 5 shows a working example wherein first transmission portion 28 of incidence part 32 is formed from a plurality of V-shapes (V-grooves), and emission part 34 is formed from a plurality of triangular shapes. On the other hand, FIG. 6 shows a working example wherein first transmission portion 28 of incidence part 32 is formed from a plurality of triangular shapes, and emission part 34 is formed from a plurality of triangular shapes. Also in the working examples of FIGS. 5 and 6, light, after entering first transmission portion 28 from light emitting unit 20, is guided to flat surface portion 36 in the direction so that the light is totally reflected by flat surface portion 36. Then, the light is refracted toward light emitting unit 20 by emission part 34, and is received by light receiving unit 22. On the other hand, light, after entering second transmission portion 30 from light emitting unit 20, is guided to flat surface portion 36 in the different direction so that the light is not totally reflected by flat surface portion 36, and then is output from second major surface 26.

FIG. 7 shows a working example wherein first transmission portion 28 of incidence part 32 is formed from one curved surface (lens-shape), and emission part 34 is formed from a plurality of triangular shapes. On the other hand, FIG. 8 shows a working example wherein first transmission portion 28 of incidence part 32 is formed from a plurality of curved surfaces (lens-shapes), and emission part 34 is formed from a plurality of triangular shapes. Also in the working examples of FIGS. 7 and 8, light, after entering first transmission portion 28 from light emitting unit 20, is guided to flat surface portion 36 in the direction so that the light is totally reflected by flat surface portion 36. However, in the working examples of FIGS. 7 and 8, the light is refracted by first transmission portion 28. As such, first transmission portion 28 is not limited to a structure for guiding the light in a straight manner, and may have various shapes depending on the locations of light emitting unit 20 and/or light receiving unit 22, etc.

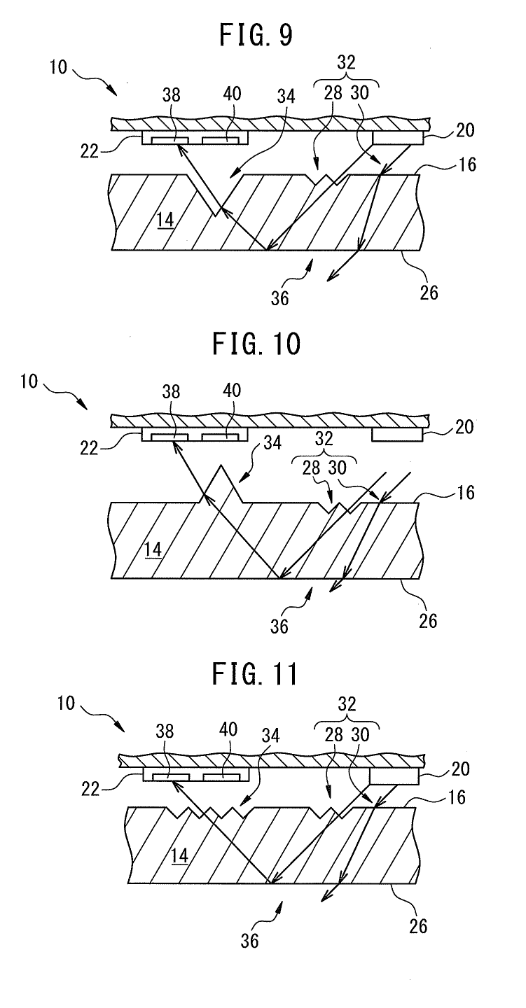

FIG. 9 shows a working example wherein first transmission portion 28 of incidence part 32 is formed from a plurality of V-shapes (V-grooves), and emission part 34 is formed from one V-shape (V-groove). On the other hand, FIG. 10 shows a working example wherein first transmission portion 28 of incidence part 32 is formed from a plurality of V-shapes (V-grooves), and emission part 34 is formed from one triangular shape. The working examples of FIGS. 9 and 10 are the same as the working example of FIG. 5 except for the shape of emission part 34, and the function of emission part 34 is the same as that of FIG. 5 in that emission part 34 refracts the light toward light emitting unit 20.

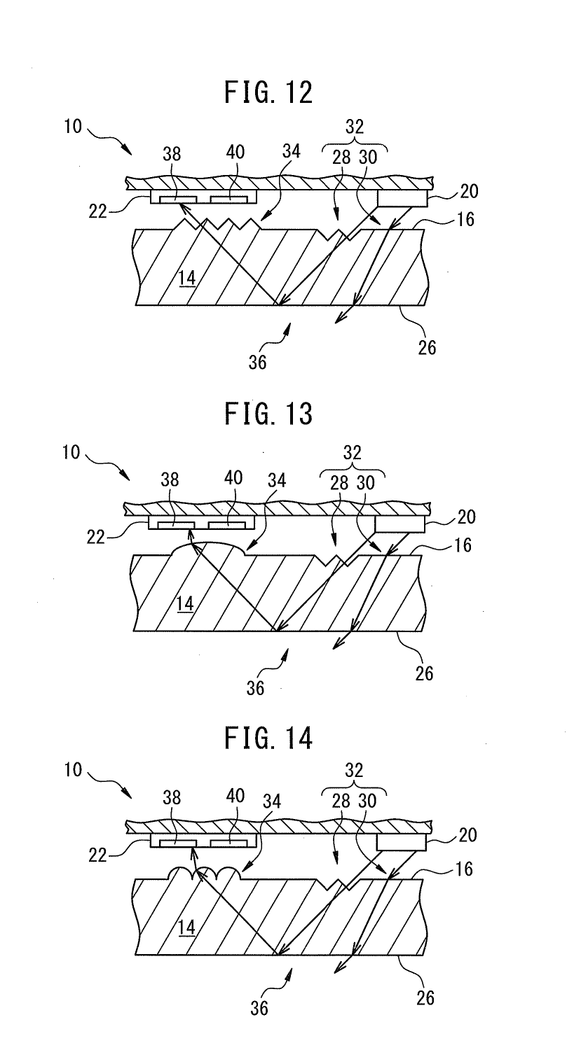

FIG. 11 shows a working example wherein first transmission portion 28 of incidence part 32 is formed from a plurality of V-shapes (V-grooves), and emission part 34 is formed from a plurality of V-shapes (V-grooves). On the other hand, FIG. 12 shows a working example wherein first transmission portion 28 of incidence part 32 is formed from a plurality of V-shapes (V-grooves), and emission part 34 is formed from a plurality of triangular shapes. The working examples of FIGS. 11 and 12 are the same as the working examples of FIGS. 9 and 10, respectively, except for the shape of emission part 34. Similarly to emission part 34 of FIGS. 2a and 2b, emission part 34 of FIGS. 11 and 12 is configured to direct the light toward light receiving unit 22 without substantially refracting the light.

FIG. 13 shows a working example wherein first transmission portion 28 of incidence part 32 is formed from a plurality of V-shapes (V-grooves), and emission part 34 is formed from one curved surface (lens-shape). On the other hand, FIG. 14 shows a working example wherein first transmission portion 28 of incidence part 32 is formed from a plurality of V-shapes (V-grooves), and emission part 34 is formed from a plurality of curved surfaces (lens-shapes). The working examples of FIGS. 13 and 14 are equivalent to the working example of FIGS. 9 and 10, respectively, except for the shape of emission part 34. Further, the function of emission part 34 of FIGS. 13 and 14 are the same as that of FIGS. 9 and 10, respectively, in that emission part 34 refracts the light toward light emitting unit 20.

Although light emitting unit 20 of each working example is illustrated as a parallel light source, light emitting unit 20 may be a point light source which emits radial light.

In the reflective optical encoder according to the present invention, an inexpensive resin-made code plate is used, and the light emitting unit and the light receiving unit may be positioned at or near the same side of the code plate. Therefore, the present invention provides an inexpensive encoder, which is compact in the axial direction thereof.

While the invention has been described with reference to specific embodiments chosen for the purpose of illustration, it should be apparent that numerous modifications could be made thereto, by one skilled in the art, without departing from the basic concept and scope of the invention.

1. A reflective optical encoder comprising:
a code plate which is formed of a resin material and has a first major surface and a second major surface opposite of the first major surface;
a light emitting unit positioned near the first major surface of the code plate; and
a light receiving unit positioned near the first major surface of the code plate,
wherein the second major surface of the code plate has a flat surface portion, and the first major surface of the code plate has an incidence part having a first transmission portion and a second transmission portion, and an emission part with a concavo-convex shape,
and wherein the first transmission portion has a V-shape, a triangular shape or a curved surface configured to guide light after entering the first transmission portion so as to be totally reflected by the flat surface portion of the second major surface, and the second transmission portion is configured to guide light after entering the second transmission portion so as not to be totally reflected by the flat surface portion of the second major surface.

2. The reflective optical encoder as set forth in claim 1, wherein the second transmission portion of the incidence part is a flat surface portion.

3. The reflective optical encoder as set forth in claim 1, wherein the concavo-convex shape of the emission part is a V-shape or triangular shape.

4. The reflective optical encoder as set forth in claim 1, wherein the concavo-convex shape of the emission part is a curved shape.
